(19) United States
(12) Patent Application Publication
(10) Pub. No.: US 2025/0122627 A1
(43) Pub. Date: Apr. 17, 2025

(54) WO3-x@CdS1-y NANOCOMPOSITE-BASED ELECTROCATALYSTS FOR GENERATING HYDROGEN

(71) Applicant: KING FAHD UNIVERSITY OF PETROLEUM AND MINERALS, Dhahran (SA)

(72) Inventors: Mohamed Jaffer Sadiq MOHAMED, Dhahran (SA); Muhammad Ashraf GONDAL, Dhahran (SA)

(73) Assignee: KING FAHD UNIVERSITY OF PETROLEUM AND MINERALS, Dhahran (SA)

(21) Appl. No.: 18/488,389

(22) Filed: Oct. 17, 2023

(51) Int. Cl. C25B 1/04; C25B 11/073

(52) U.S. Cl. CPC C25B 1/04; C25B 11/073

(57) ABSTRACT

A method of generating hydrogen including applying a potential of greater than 0 to 2.0 V to an electrochemical cell that is partially submerged in an aqueous solution. On applying the potential, water in the aqueous solution is reduced, and thereby forms hydrogen. The electrochemical cell includes an electrocatalyst and a counter electrode. The electrocatalyst includes a substrate, WO₃₋ₓ nanosheets, and CdS_{1-y} nanospheres, in which, x is from greater than 0 to less than 3 and y is from greater than 0 to less than 1. The CdS_{1-y} nanospheres are dispersed on the WO₃₋ₓ nanosheets to form a nanocomposite, which is dispersed on a surface of the substrate. The WO₃₋ₓ nanosheets have an average length of 600-800 nanometers (nm) and an average width of 300-500 nm, and the CdS_{1-y} nanospheres have an average diameter of 10-50 nm.

### STATEMENT OF PRIOR DISCLOSURE BY INVENTOR

Aspects of the present disclosure are described in M. J. S. Mohamed, M. A. Gondal, M. Hassan, M. A. Almessiere, A. A. Tahir, A. Roy. “Effective Hydrogen Production from Alkaline and Natural Seawater using WO₃₋ₓ@CdS₁₋ₓ Nanocomposite-Based Electrocatalysts”; ACS Omega; Sep. 11, 2023; 8; 37; 33332-33341, incorporated herein by reference in its entirety.

### STATEMENT OF ACKNOWLEDGEMENT

Support provided by the King Fahd University of Petroleum and Minerals (KFUPM) is gratefully acknowledged.

### BACKGROUND

### Technical Field

The present disclosure is directed to an electrocatalyst, and particularly, to a WO₃₋ₓ@CdS_{1-y} nanocomposite-based electrocatalyst for generating hydrogen.

### DESCRIPTION OF RELATED ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Hydrogen is an energy resource that can be produced at low cost via water electrolysis, offering a versatile resource of renewable energy. The alkaline electrocatalytic hydrogen evolution reaction (HER) is preferable to acidic and neutral electrolytes because of less corrosion for equipment and transition metal-based electrodes. Compared to acidic electrolytes, when H⁺ is produced in the alkaline medium, an extra dissociation process called the Volmer mechanism (H₂O+e⁻→H⁺+OH⁻) is involved. Further, seawater electrolysis is the most environmentally friendly method of producing hydrogen. However, seawater electrolysis is very challenging, for example the corresponding high-performance electrocatalysts must be able to overcome poor conductivity, severe corrosivity, poisoning influence, and poor long-term stability. Despite sucessful hydrogen evolution activity (HEA) of platinum (Pt)-based electrocatalysts, owing to almost zero Gibbs free energy, the scarcity and high cost of Pt limits their widespread application. To overcome these problems, highly stable, durable, non-toxic, efficient, and low-cost alkali metal-based HER electrocatalysts, including various oxides, sulfides, phosphides, carbides, and hydroxides decades have been developed.

Tungsten trioxide (WO₃) has been used for energy conversion and storage due to its flexible band gap, strong electron acceptability, abundance, environmental amiability, mild corrosion resistance, and stability against water. However, properties like low intrinsic conductivity and inadequate exposure to active sites of WO₃ limit its electrocatalytic application. To resolve these issues, various strategies such as doping, electrochemically active surface area (ECSA) widening, morphology modification, phase engineering, vacancy generation, and heterostructure formation have been adopted to improve the electrical structures and active sites at the surfaces, interfaces, and edges. WO₃ is frequently found in substoichiometric compositions, denoted as WO₃₋ₓ, where 0<x<1. The rapid reduction of oxygen in these compositions leads to oxygen vacancies (OVs) forming when oxygen atoms are released onto the metal oxide surfaces. These OVs, which become rich in localized electrons, account for the unique physicochemical properties of WO₃₋ₓ. Such properties include optical characteristics, electron transport, charge carrier separation, and surface texture. Consequently, this results in a high number of active sites suitable for catalysis.

Due to high electrical conductivity, semiconducting inorganic transition metal chalcogenides, like cadmium sulfide (CdS), have been used as a strong electrocatalyst. Introducing sulfur vacancies (SVs) into CdS can create more active sites and enhance the charge transfer rates, leading to excellent electrocatalytic performance. Consequently, CdS has emerged as an intriguing contender for WO₃ coupling in the HER. The excellent solid aqueous stability of CdS can be advantageous to improve the corrosion behavior and HER-mediated electrocatalytic activity of WO₃ encapsulated CdS nanocomposites. Enhancing the catalytic activity per unit area is imperative to achieve a highly efficient electrocatalyst for the HER. Hence, a need remains to improve the electrical traits of WO₃ through the activation of vacancies and defects in its inert basal planes, thereby improving hydrogen production.

Accordingly, it is one object of the present disclosure to develop a method for generating hydrogen with a nanocomposite-based electrocatalyst in alkaline and natural seawater media.

### SUMMARY

In an exemplary embodiment, a method of generating hydrogen is described. The method includes applying a potential greater than 0 to 2.0 V to an electrochemical cell. The electrochemical cell is at least partially submerged in an aqueous solution. On applying the potential, water in the aqueous solution is reduced, thereby forming hydrogen. The electrochemical cell includes an electrocatalyst and a counter electrode. The electrocatalyst includes a substrate, WO₃₋ₓ nanosheets, and CdS_{1-y} nanospheres, in which, x is from greater than 0 to less than 3 and y is from greater than 0 to less than 1. The CdS_{1-y} nanospheres are dispersed on the WO₃₋ₓ nanosheets to form a nanocomposite, which is dispersed on a surface of the substrate. The WO₃₋ₓ nanosheets have an average length of 600-800 nanometers (nm) and an average width of 300-500 nm, and the CdS_{1-y} nanospheres have an average diameter of 10-50 nm.

In some embodiments, the nanocomposite includes 1-40 wt. % of the CdS_{1-y} nanospheres, based on a total weight of the nanocomposite.

In some embodiments, the nanocomposite includes 60-99 wt. % of the WO₃₋ₓ nanosheets, based on a total weight of the nanocomposite.

In some embodiments, the WO₃₋ₓ nanosheets have a monoclinic crystal structure.

In some embodiments, the CdS_{1-y} nanospheres have a hexagonal crystal structure.

In some embodiments, the WO₃₋ₓ nanosheets have a thickness of less than 5 nm.

In some embodiments, particles of the CdS_{1-y} nanospheres form clusters having an average size of 500-1,000 nm.

In some embodiments, the clusters at least partially cover a surface of particles of the WO₃₋ₓ nanosheets.

In some embodiments, the nanocomposite includes W, S, Cd, and O.

In some embodiments, the nanocomposite includes 40-60 wt. % W, 1-10 wt. % S, 5-15 wt. % Cd, and 20-40 wt. % O.

In some embodiments, the CdS_{1-y} nanospheres have at least 1% sulfur vacancies.

In some embodiments, the WO₃₋ₓ nanosheets have at least 1% oxygen vacancies.

In some embodiments, the nanocomposite is made by a method including mixing the WO₃₋ₓ nanosheets and the CdS_{1-y} nanospheres in water to form a mixture, and irradiating the mixture for at least 10 minutes with a laser to form the nanocomposite.

In some embodiments, the method of making the nanocomposite further includes sonicating the mixture for at least 30 minutes prior to the irradiating.

In some embodiments, the laser has a wavelength of 500-600 nm.

In some embodiments, the WO₃₋ₓ nanosheets are made by a method including mixing an acid and a tungstate salt in a solvent and sonicating for at least 30 minutes to form a suspension. The method further includes adding a reducing agent to the suspension to form a precipitate, and calcining the precipitate for 1-10 hours at a temperature of 600-1,000° C. to form the WO₃₋ₓ nanosheets.

In some embodiments, the CdS_{1-y} nanospheres are made by a method including mixing a cadmium salt in a solvent to form a mixture, and adding a reducing agent to the mixture and sonicating for at least 30 minutes to form a second mixture. The method further includes adding a sulfur salt to the second mixture to form the CdS_{1-y} nanospheres.

In some embodiments, the electrocatalyst has an overpotential of 180-200 millivolts (mV) per decade.

In some embodiments, the aqueous solution includes at least one base selected from the group consisting of an alkaline earth metal hydroxide and an alkali metal hydroxide.

In some embodiments, the aqueous solution is seawater.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a schematic flow diagram depicting a method of synthesizing WO₃₋ₓ, according to certain embodiments;

FIG. 1B is a schematic flow diagram depicting a method of synthesizing CdS_{1-y}, according to certain embodiments;

FIG. 1C is a schematic flow diagram depicting a method of synthesizing a nanocomposite of WO₃₋ₓ and CdS_{1-y}, according to certain embodiments;

FIG. 2A is a schematic pictorial representation depicting the synthesis of WO₃₋ₓ, according to certain embodiments;

FIG. 2B is a schematic pictorial representation depicting the synthesis of CdS_{1-y}, according to certain embodiments;

FIG. 2C is a schematic pictorial representation depicting synthesis of the nanocomposite, according to certain embodiments;

FIG. 3 is an X-ray diffraction (XRD) pattern of the WO₃₋ₓ, CdS_{1-y}, and nanocomposite, according to certain embodiments;

FIG. 4A is a scanning electron microscopic (SEM) image and the corresponding energy dispersive X-ray spectroscopy (EDX) spectra of the WO₃₋ₓ, according to certain embodiments;

FIG. 4B is a SEM image and the corresponding EDX spectra of the CdS_{1-y}, according to certain embodiments;

FIG. 4C is a SEM image and the corresponding EDX spectra of the nanocomposite, according to certain embodiments;

FIG. 5A is a transmission electron microscopic (TEM) image of the WO₃₋ₓ, according to certain embodiments;

FIG. 5B is a TEM image of the CdS_{1-y}, according to certain embodiments;

FIG. 5C is a TEM image of the nanocomposite, according to certain embodiments;

FIG. 5D is a high-resolution transmission electron microscopic (HRTEM) image of the nanocomposite, according to certain embodiments;

FIG. 6A is an elemental map of the WO₃₋ₓ, according to certain embodiments;

FIG. 6B is an elemental map of the CdS_{1-y}, according to certain embodiments;

FIG. 6C is an elemental map of the nanocomposite, according to certain embodiments;

FIG. 7A is an X-ray photoelectron spectroscopy (XPS) survey spectrum of the nanocomposite, according to certain embodiments;

FIG. 7B is a XPS spectrum corresponding to a core-level spectra for C 1s of the nanocomposite, according to certain embodiments;

FIG. 7C is a XPS spectrum corresponding to a core-level spectra for Cd 3d of the nanocomposite, according to certain embodiments;

FIG. 7D is a XPS spectrum corresponding to a core-level spectra for S 2p of the nanocomposite, according to certain embodiments;

FIG. 7E is a XPS spectrum corresponding to a core-level spectra for W 4f of the nanocomposite, according to certain embodiments;

FIG. 7F is a XPS spectrum corresponding to a core-level spectra for O 1s of the nanocomposite, according to certain embodiments;

FIG. 8A is a polarization plot of the WO₃₋ₓ, CdS_{1-y}, and nanocomposite, according to certain embodiments;

FIG. 8B shows a hydrogen evolution reaction (HER) performance of the WO₃₋ₓ, CdS_{1-y}, nanocomposite, according to certain embodiments;

FIG. 8C shows a cyclic voltammetry (CV) curve of the WO₃₋ₓ, according to certain embodiments;

FIG. 8D shows a CV curve of the CdS_{1-y}, according to certain embodiments;

FIG. 8E shows a CV curve of the nanocomposite, according to certain embodiments;

FIG. 8F shows an electrochemical double layer capacitance (Cdl) plot of the WO₃₋ₓ, CdS_{1-y}, and nanocomposite, according to certain embodiments;

FIG. 9A shows calculated values of Cdl and electrochemically active surface area (ECSA), according to certain embodiments;

FIG. 9B shows Nyquist plots of the WO₃₋ₓ, CdS_{1-y}, and nanocomposite, according to certain embodiments;

FIG. 9C shows Tafel plots of the WO₃₋ₓ, CdS_{1-y}, and nanocomposite, according to certain embodiments;

FIG. 9D shows stability after 1000 CV cycles (inset) and chronopotentiometry plot of the nanocomposite, according to certain embodiments;

FIG. 10 shows a SEM micrograph of the nanocomposite captured after the stability test, according to certain embodiments;

FIG. 11A shows a linear sweep voltammetry (LSV) curve of the nanocomposite, according to certain embodiments;

FIG. 11B shows an overpotential histogram of the nanocomposite, according to certain embodiments;

FIG. 11C shows a chronopotentiometry (CP) curve of the nanocomposite, according to certain embodiments; and

FIG. 11D shows overpotential comparison of the nanocomposite with known compounds at a current density of 10 mA/cm² in seawater circumstances, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Where a numerical limit or range is stated herein, the endpoints are included. Also, all values and subranges within a numerical limit or range are specifically included as if explicitly written out.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

As used herein, ‘electrode’ refers an electrical conductor used to contact a non-metallic part of a circuit e.g., a semiconductor, an electrolyte, a vacuum, or air.

As used herein, ‘working electrode’ refers to the electrode in an electrochemical cell/device/sensor on which the electrochemical reaction of interest is occurring.

As used herein, ‘counter-electrode’ is an electrode used in an electrochemical cell for voltametric analysis or other reactions in which an electric current is expected to flow.

As used herein, the term ‘glassy carbon’ refers to a non-graphitizing carbon that combines glassy and ceramic properties with those of graphite.

As used herein, “particle size” and “pore size” may be considered the lengths or longest dimensions of a particle and of a pore opening, respectively.

As used herein, the term ‘electrochemical cell’ refers to a device capable of generating electrical energy from chemical reactions or using electrical energy to cause chemical reactions.

As used herein, the term “current density” refers to the amount of electric current traveling per unit cross-section area.

As used herein, the term “Tafel slope” refers to the relationship between the overpotential and the logarithmic current density.

As used herein, the term ‘water splitting’ refers to the chemical reaction in which water is broken down into oxygen and hydrogen.

The present disclosure is intended to include all hydration states of a given compound or formula, unless otherwise noted or when heating a material.

Aspects of the present disclosure are directed to a method of generating hydrogen, and in particular to synthesizing electrocatalytic nanocomposites including WO₃₋ₓ and CdS_{1-y} (WCSNCs) via ultrasonic-assisted laser irradiation. The natural seawater electrolysis of the prepared catalysts had high performance regarding the electrocatalytic hydrogen evolution reaction (HER) activity and stability. The enhanced performance of the prepared electrocatalyst was ascribed to the synergy of sulfur vacancies in CdS_{1-y} and oxygen vacancies in WO₃₋ₓ, boosting the electrochemically active surface area, rate of charge separation, and transfer, electrocatalytic active sites as well as the acceleration of alkaline and natural seawater HER.

According to an aspect of the present disclosure, an electrocatalyst, also referred to as a catalyst, is described. The electrocatalyst includes a substrate onto which is dispersed a nanocomposite. The substrate may be made from a material selected from the group consisting of platinum, gold, and carbon. In the preferred embodiment, the substrate is made of carbon. In a preferred embodiment, the substrate is glassy carbon. The carbon substrate may be a porous material. Also, pores of the carbon substrate may exist in many shapes, such as cubical, conical, cuboidal, pyramidical, or cylindrical. In an embodiment, the substrate surface is at least 50% coated with the nanocomposite, preferably 60%, 70%, 80%, 90%, or 100% coated. The substrate is coated by any method known in the art, including but not limited to drop-casting, spin coating, and using an automatic coating machine.

The nanocomposite includes CdS_{1-y} nanoparticles, where y is from greater than 0 to less than 1 and may include 0.1, 0.2. 0.3, 0.4, 0.5, 0.6, 0.7, 0.8, 0.9, all sub-ranges between 0 to 1. In some embodiments, the nanoparticles may exist in other morphological forms such as nanowires, nanospheres, nanorods, nanocrystals, nanorectangles, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nano-urchins, nanoflowers, etc. and mixtures thereof. In a preferred embodiment, the CdS_{1-y} nanoparticles have substantially spherical morphology, forming nanospheres.

The CdS_{1-y} nanospheres have an average diameter of 10-50 nm and can include CdS_{1-y} nanospheres having diameters of about 10, 15, 20, 25, 30, 35, 40, 45, 46, 47, 48, 49, and 50 nm. In an embodiment, particles of the CdS_{1-y} nanospheres form clusters having an average size of 500-1,000 nm, preferably 550, 600, 650, 700, 750, 800, 850, 900, 950, and 1000 nm. In an embodiment, the CdS_{1-y} nanoparticles have a triclinic, monoclinic, orthorhombic, tetragonal, trigonal, hexagonal, or cubic crystal structure. In a specific embodiment, the CdS_{1-y} nanospheres have a hexagonal crystal structure. In a preferred embodiment, the CdS_{1-y} nanoparticles have at least 1% sulfur vacancies, preferably 5, 10, 15, 20, 25, 30, 35, 40, 45, 50, 55, 60, 65, 70, 75, 80, 85, 90, or 95% sulfur vacancies. Vacancies are defined as absence of an atom or molecule from a point that it would normally occupy in a crystal.

The CdS_{1-y} nanospheres have cadmium in a weight percentage range of 75-85%, preferably 75%, preferably 76%, preferably 77%, preferably 78%, preferably 79%, preferably 79.8%, and sulfur in the range of 15-25%, preferably 16%, preferably 17%, preferably 18%, preferably 19%, preferably 20%, preferably 20.2%, based on the total weight of the CdS_{1-y}.

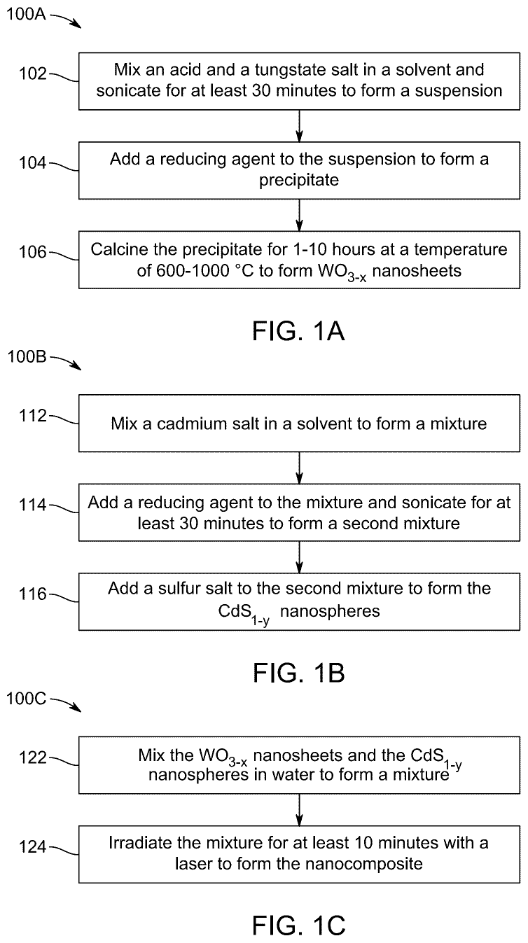

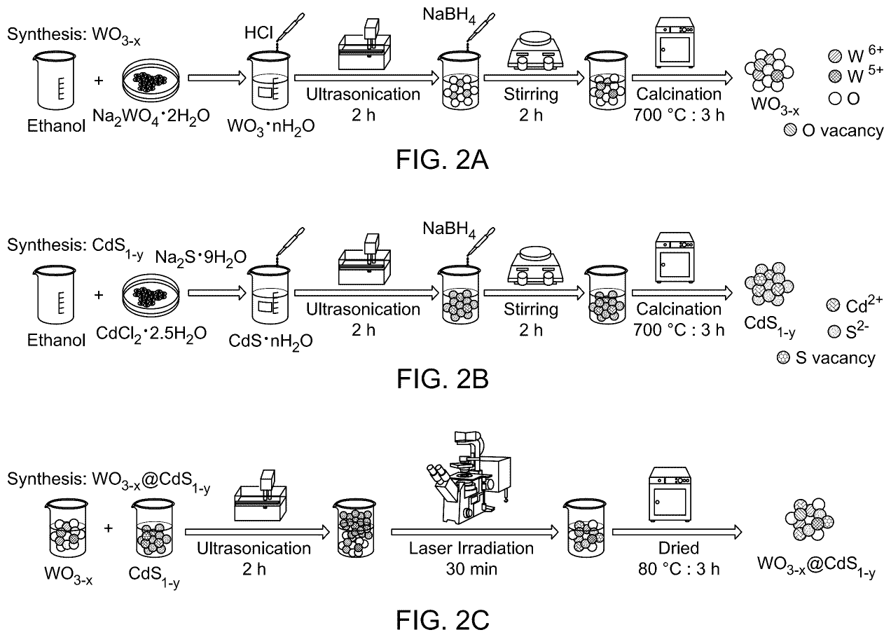

In some embodiments, the CdS_{1-y} nanospheres are made by a method 100B (FIG. 1B). According to the present disclosure, the method 100B corresponds to synthesizing of CdS_{1-y} nanospheres using an ultrasonic process (shown in FIG. 2B). A schematic flow diagram of the method 100B for making the CdS_{1-y} nanospheres is shown in FIG. 1B and the method 100B is further illustrated with reference to the ultrasonic process described in FIG. 2B.

At step 112, the method 100B includes mixing a cadmium salt in a solvent to form a mixture. Suitable examples of the cadmium salts include, but are not limited to, cadmium chloride, cadmium sulfate, cadmium nitrate, cadmium sulfide, cadmium acetate, cadmium carbonate, cadmium hydroxide, cadmium stearate, cadmium cyanide, cadmium phosphide, and/or combinations thereof. In a preferred embodiment, the cadmium salt is cadmium chloride. In some embodiments, the cadmium salt may include all its hydrates, for example, monohydrate, hemipentahydrate, tetrahydrate, and/or combinations thereof. In a preferred embodiment, the cadmium salt includes hemipentahydrate forms of the cadmium salt. In a specific embodiment, the cadmium salt is cadmium chloride hemi (pentahydrate) or CdCl₂·2.5H₂O. The cadmium salt is mixed in a solvent. The solvent may be an organic or an inorganic solvent. In a preferred embodiment, solvent is an organic solvent. Suitable examples of the organic solvent include tetrahydrofuran, ethyl acetate, dimethylformamide (DMF), acetonitrile, acetone, dimethyl sulfoxide, nitromethane, propylene carbonate, ethanol, formic acid, n-butanol, methanol, benzene, cyclohexane, ethyl acetate, dichloromethane, toluene, and diethyl ether, or any combination thereof. In a preferred embodiment, the organic solvent is ethanol. The cadmium salt was mixed with the solvent for 1-10 hours, preferably 2-9 hours, preferably 3-8 hours, preferably 4-7 hours, preferably 5-6 hours, preferably 6 hours to form the mixture.

At step 114, the method 100B includes adding a reducing agent to the mixture and sonicating for at least 30 minutes to form a second mixture. Suitable examples of the reducing agents include sodium borohydride, zinc amalgam, lithium aluminum hydride (LiAlH₄), diborane, sodium amalgam, sodium lead alloy, nascent hydrogen, thiosulfates, oxalic acid, formic acid, etc. In a preferred embodiment, the reducing agent is sodium borohydride. After the addition of the reducing agent, the mixture may be sonicated for 30-60 minutes, preferably 30-50 minutes, preferably 30-40 minutes, and preferably 30 minutes to ensure complete mixing for the formation of the second mixture.

At step 116, the method 100B includes adding a sulfur salt to the second mixture to form the CdS_{1-y} nanospheres. Suitable examples of sulfur salt include, but are not limited to, sulfites, sulfides, hydrosulfites, and thiosulfates of sodium, potassium, lithium, calcium, barium, etc. In a preferred embodiment, the sulfur salt is sodium sulfide; more specifically, (Na₂S—9H₂O). After the addition of the sulfur salt, the second mixture may be sonicated for 30-120 minutes, preferably 40-120 minutes, preferably 60-120 minutes, preferably 90 minutes, and preferably 120 minutes for the formation of the CdS_{1-y} nanospheres. In some embodiments, the CdS_{1-y} nanospheres may be washed one or more times, preferably with water, to remove any unreacted sulfur salts. After washing, the CdS_{1-y} nanospheres may be dried for 60-100° C., preferably 70-90° C., preferably 80° C. to form the purified CdS_{1-y} nanospheres. The drying can be done by using heating appliances such as ovens, microwaves, autoclaves, hot plates, heating mantles and tapes, oil baths, salt baths, sand baths, air baths, hot-tube furnaces, and hot-air guns.

The nanocomposite further includes WO₃₋ₓ nanoparticles, where x is from greater than 0 to less than 3 and may include 0.1, 0.2. 0.3, 0.4, 0.5, 0.6, 0.7, 0.8, 0.9, 1,1.2, 1.5, 2, 1.2, 2.4, 2.6, 2.8, 2.9, 2.95, and all sub-ranges between 0 to 3. In some embodiments, the nanoparticles may exist in other morphological forms such as nanowires, nanospheres, nanorods, nanocrystals, nanorectangles, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nanosheets, nano-urchins, nanoflowers, etc. and mixtures thereof. In a preferred embodiment, the WO₃₋ₓ nanoparticles are in the form of nanosheets.

The WO₃₋ₓ nanosheets have an average length of 600-800 nanometers (nm) and can include WO₃₋ₓ nanosheets having lengths of about 610, 620, 630, 640, 650, 660, 670, 670, 680, 690, 700, 710, 720, 730, 740, 750, 760, 770, 780, 790, and 800 nm. The average width is about 300-500, preferably about 310, 320, 330, 340, 350, 360, 370, 380, 390, 400, 410, 420, 430, 440, 450, 460, 470, 480, 490, and 500 nm. The thickness of the WO₃₋ₓ nanosheets is less than 5 nm and can be about 0.1, 1, 1.5, 2, 2.5, 3, 3.5, 4, 4.5, 4.6, 4.7, 4.8, 4.9, 4.99 nm.

In an embodiment, the WO₃₋ₓ nanoparticles have a triclinic, monoclinic, orthorhombic, tetragonal, trigonal, hexagonal, or cubic crystal structure. In a specific embodiment, the WO₃₋ₓ nanospheres have a monoclinic crystal structure. In a preferred embodiment, the WO₃₋ₓ nanoparticles have at least 1% oxygen vacancies, preferably 5, 10, 15, 20, 25, 30, 35, 40, 45, 50, 55, 60, 65, 70, 75, 80, 85, 90, or 95% oxygen vacancies.

The WO₃₋ₓ nanosheets include tungsten in a weight percentage range of 65-75%, preferably 65%, preferably 66%, preferably 67%, preferably 68%, preferably 69%, preferably 70%, preferably 71%, preferably 72%, preferably 72.9%, and oxygen in the range of 25-35%, preferably 26%, preferably 27%, preferably 27.1%, based on the total weight of the WO₃₋ₓ.

In some embodiments, the WO₃₋ₓ nanosheets are made by a method 100A (FIG. 1A). According to the present disclosure, the method 100A corresponds to synthesizing of WO₃₋ₓ nanosheets using an ultrasonic process (shown in FIG. 2A). A schematic flow diagram of the method 100A for making the WO₃₋ₓ nanosheets is shown in FIG. 1A and the method 100A is further illustrated with reference to the ultrasonic process described in FIG. 2A. The order in which the method 100A is described is not intended to be construed as a limitation, and any number of the described method steps can be combined in any order to implement the method 100A. Additionally, individual steps may be removed or skipped from the method 100A without departing from the spirit and scope of the present disclosure.

At step 102, the method 100A includes mixing an acid and a tungstate salt in a solvent and sonicating for at least 30 minutes to form a suspension. Suitable examples of the acid include, but is not limited to, sulfuric acid, hydrochloric acid, nitric acid, phosphoric acid, hydrofluoric acid, boric acid, perchloric acid, carbonic acid, acetic acid, formic acid, hydrobromic acid, sulfamic acid, hypochlorous acid, sulfurous acid, hydroiodic acid, hypophosphorous acid, phosphorous acid, fumaric acid, iodic acid, chromic acid, chloric acid, hydrogen cyanide, nitroxyl, oxalic acid, etc. In a preferred embodiment, the acid is hydrochloric acid. The hydrochloric acid is mixed with the tungsten salt. Suitable examples of the tungsten salt include, but is not limited to, sodium tungstate, tungsten trioxide, tungstic acid, calcium tungstate, and/or combinations thereof. In a preferred embodiment, the tungsten salt is sodium tungstate, more specifically, Na₂WO₄·2H₂O. The acid and the tungsten salt are mixed in a solvent. The solvent may be an organic or an inorganic solvent. In a preferred embodiment, solvent is an organic solvent. Suitable examples of the organic solvent include tetrahydrofuran, ethyl acetate, dimethylformamide (DMF), acetonitrile, acetone, dimethyl sulfoxide, nitromethane, propylene carbonate, ethanol, formic acid, n-butanol, methanol, benzene, cyclohexane, ethyl acetate, dichloromethane, toluene, and diethyl ether, or any combination thereof. In a preferred embodiment, the organic solvent is ethanol. The concentration of the Na₂WO₄·2H₂O is in a range of 0.1 to 2 M, preferably 0.2 to 1.9 M, preferably 0.5 to 1.5 M, preferably 0.8 to 1.2 M, preferably 1 M. The acid and the tungstate salt in the solvent are sonicated for at least 30 minutes, preferably 40 minutes, preferably 50 minutes, preferably 60 minutes, preferably 75 minutes, preferably 90 minutes, preferably 100 minutes, preferably 120 minutes, to form a suspension. The suspension was stirred at room temperature for 1-10 hours, preferably 2-9 hours, preferably 3-8 hours, preferably 4-7 hours, preferably 5-6 hours, preferably 6 hours.

At step 104, the method 100A includes adding a reducing agent to the suspension to form a precipitate. Suitable examples of the reducing agents include sodium borohydride, zinc amalgam, lithium aluminum hydride (LiAlH₄), diborane, sodium amalgam, sodium lead alloy, nascent hydrogen, thiosulfates, oxalic acid, formic acid, etc. In a preferred embodiment, the reducing agent is sodium borohydride. After the addition of the reducing agent, the suspension may be stirred for 1-3 hours, preferably 1.4-2.5 hours, preferably 2 hours, to form the precipitate. The precipitate may be dried for 60-100° C., preferably 70-90° C., preferably 80°° C., for 5-10 hours, preferably 6-9 hours, preferably 7-8 hours, preferably 8 hours, to form the WO₃₋ₓ nanosheets. The drying can be done by using heating appliances such as ovens, microwaves, autoclaves, hot plates, heating mantles and tapes, oil baths, salt baths, sand baths, air baths, hot-tube furnaces, and hot-air guns.

At step 106, the method 100A includes calcining the precipitate for 1-10 hours at a temperature of 600-1000° C. to form the WO₃₋ₓ nanosheets. The calcination may be carried out by placing the precipitate into a furnace such as a tube furnace, for example, in a ceramic crucible (e.g., an alumina crucible) or other forms of containment, and heating to the temperatures described above. The furnace is preferably equipped with a temperature control system, which may provide a heating rate of up to 50° C./min, or preferably up to 40° C./min, or preferably up to 30° C./min, preferably up to 20° C./min, preferably up to 10° C./min, preferably up to 5° C./min, till the temperature in the furnace reaches about 600-1000° C., preferably 650-900° C., preferably 700-900° C., preferably 700°° C. The calcination is carried out for a period of 2-5 hours, preferably 3-4 hours, preferably 3 hours, to obtain the WO₃₋ₓ nanosheets.

In an embodiment, the nanocomposite includes 1-40 wt. %, preferably 5-35 wt. %, preferably 10-30 wt. %, preferably 15-25 wt. %, preferably 20 wt. % of the CdS_{1-y} nanospheres based on the total weight of the nanocomposite and 60-99 wt. %, preferably 65-95 wt. %, preferably 70-90 wt. %, preferably 75-85 wt. %, preferably 76 wt. %, preferably 77 wt. %, preferably 78 wt. %, preferably 79 wt. %, preferably 80 wt. % of the WO₃₋ₓ nanosheets based on the total weight of the nanocomposite.

In some embodiments, the nanocomposite includes, preferably only includes, tungsten (W), sulfur (S), cadmium (Cd), and oxygen (O). In some embodiments, the nanocomposite includes 40-60 wt. %, preferably 42-68 wt. %, preferably 44-56 wt. %, preferably 46-54 wt. %, preferably 48-52 wt. %, preferably 49 wt. %, preferably 50 wt. %, preferably 51.2 wt. % of W, 1-10 wt. %, preferably 2-9 wt. %, preferably 3-8 wt. %, preferably 4-7.5 wt. %, preferably 5 wt. %, preferably 6 wt. %, preferably 6.2 wt. % of S; 5-15 wt. %, preferably 6-14 wt. %, preferably 7-13 wt. %, preferably 8 wt. %, preferably 9 wt. %, preferably 10 wt. %, preferably 11 wt. %, preferably 12 wt. %, preferably 12.5 wt. % of Cd; and 20-40 wt. %, preferably 25-35 wt. %, preferably 27-33 wt. %, preferably 28 wt. %, preferably 29 wt. %, preferably 30 wt. %, preferably 30.1 wt. % of O.

In the nanocomposite, the CdS_{1-y} nanospheres are dispersed on the WO₃₋ₓ nanosheets. In an embodiment, when the CdS_{1-y} nanospheres are in a form of clusters, the clusters at least partially cover the surface of particles of the WO₃₋ₓ nanosheets. In an embodiment, at least 10%, preferably 20%, preferably 30%, preferably 40%, preferably 50%, preferably 60%, preferably 70%, preferably 80%, preferably 90%, or 100% of the surface of the WO₃₋ₓ nanosheets are covered by the clusters. In a preferred embodiment, the CdS_{1-y} nanospheres are grown directly on the WO₃₋ₓ nanosheets.

In some embodiments, the nanocomposite is made by a method 100C (FIG. 1C). According to the present disclosure, the method 100C corresponds to the synthesizing of WO₃₋ₓ@CdS_{1-y} nanocomposite using an ultrasonic-assisted irradiation technique (shown in FIG. 2C). A schematic flow diagram of the method 100C for making the WO₃₋ₓ@CdS_{1-y} nanocomposite is shown in FIG. 1C and the method 100C is further illustrated with reference to the ultrasonic process described in FIG. 2C.

At step 122, the method 100C includes mixing the WO₃₋ₓ nanosheets and the CdS_{1-y} nanospheres in water to form a mixture. In some embodiments, the mixture may be sonicated for 10-120 minutes, preferably 20-110 minutes, preferably 30-100 minutes, and preferably for 30-90 minutes to ensure thorough mixing.

At step 124, the method 100C includes irradiating the mixture for at least 10 minutes with a laser to form the WO₃₋ₓ@CdS_{1-y} nanocomposite. In some embodiments, the mixture was placed and irradiated by the laser for 30 minutes. The laser has a wavelength of 500-600 nm, preferably 525-575 nm, or about 550 nm. The method of the present disclosure obviates the need for post-synthesis purification techniques, as no catalysts or intermediary chemicals were used to complete the laser irradiation procedure. Consequently, the synthesized products were pure without any contaminants.

A method of generating hydrogen gas is described. The method includes applying a potential of greater than 0 to 2.0 V preferably 0.2 to 1.8 V, 0.4 to 1.6 V, 0.6 to 1.4 V, 0.8 to 1.2 V, or about 1 V, to an electrochemical cell. The electrochemical cell is at least partially submerged in an aqueous solution, preferably 50%, 60%, 70%, 80%, 90%, or fully submerged. The electrochemical cell includes an electrocatalyst and a counter electrode. As used herein the electrocatalyst is the substrate, the WO₃₋ₓ nanosheets, and the CdS_{1-y} nanospheres. The electrocatalyst forms the working electrode, while the counter electrode forms the auxiliary electrode.

The outer surface of the counter electrode includes an inert, electrically conducting chemical substance, such as platinum, gold, or carbon. The carbon may be in the form of graphite or glassy carbon. Alternatively, the counter electrode may comprise some other electrically-conductive material such as platinum-iridium alloy, iridium, titanium, titanium alloy, stainless steel, gold, cobalt alloy, and/or some other electrically-conductive material, where an “electrically-conductive material” as defined here is a substance with an electrical resistivity of at most 10⁻⁶ Ω·m, preferably at most 10⁻⁷ Ω·m, more preferably at most 10⁻⁸ Ω·m at a temperature of 20-25° C. In one embodiment, the counter electrode may be a wire, a rod, a cylinder, a tube, a scroll, a sheet, a piece of foil, a woven mesh, a perforated sheet, or a brush. The counter electrode material should thus be sufficiently inert to withstand the chemical conditions in the electrolyte solution, such as acidic or basic pH values, without substantially degrading during the electrochemical reaction. The counter electrode preferably should not leach out any chemical substance that interferes with the electrochemical reaction or lead to undesirable contamination of either electrode.

In one embodiment, the counter electrode may be a wire, a rod, a cylinder, a tube, a scroll, a sheet, a piece of foil, a woven mesh, a perforated sheet, or a brush. The counter electrode material should thus be sufficiently inert to withstand the chemical conditions in the electrolyte solution, such as acidic or basic pH values, without substantially degrading during the electrochemical reaction. The counter electrode preferably should not leach out any chemical substance that interferes with the electrochemical reaction or lead to undesirable contamination of either electrode.

In one embodiment, the electrochemical cell further includes a reference electrode in contact with the electrolyte solution. A reference electrode is an electrode that has a stable and well-known electrode potential. The high stability of the electrode potential is usually reached by employing a redox system with constant (buffered or saturated) concentrations of each relevant species of the redox reaction. A reference electrode may enable a potentiostat to deliver a stable voltage to the working electrode or the counter electrode. The reference electrode may be RHE, a standard hydrogen electrode (SHE), a normal hydrogen electrode (NHE), a saturated calomel electrode (SCE), a Cu-Cu(II) sulfate electrode (CSE), a silver chloride electrode (Ag/AgCl), a pH-electrode, a palladium-hydrogen electrode, a dynamic hydrogen electrode (DHE), a mercury-mercurous sulfate electrode, or some other type of electrode. In a preferred embodiment, the reference electrode is Ag/AgCl.

In an embodiment, the aqueous solution includes water and an inorganic base. The water may be tap water, distilled water, bidistilled water, deionized water, deionized distilled water, reverse osmosis water, seawater, and/or some other water. In one embodiment, the sea water is bidistilled to eliminate trace metals. Preferably, the water is seawater, and at 25° C. has an electrical conductivity at less than 10 micro siemens per centimeter (μS·cm⁻¹), preferably less than 2 μS·cm⁻¹. In some embodiments, the water is alkaline water. The alkaline water has a pH in a range of 7-13.

The aqueous solution includes at least one base selected from the group consisting of an alkaline earth metal hydroxide and an alkali metal hydroxide. The base may be selected from the group consisting of an alkaline earth metal hydroxide such as beryllium hydroxide (Be(OH)₂), magnesium hydroxide (Mg(OH)₂), strontium hydroxide (Sr(OH)₂), and calcium hydroxide (Ca(OH)₂) and an alkali metal hydroxide such as lithium hydroxide (LiOH), sodium hydroxide (NaOH), potassium hydroxide (KOH) and rubidium hydroxide (RbOH), and cesium hydroxide (CsOH). In a preferred embodiment, the base is potassium hydroxide.

On applying the potential, the aqueous solution is reduced, thereby forming hydrogen gas. The electrocatalyst has an overpotential of 180-200 mV, preferably 185-195 mV or about 191 mV per decade. Also, the overpotential does not vary by more than 5%, preferably 4%, 3%, 2%, or 1% after the potential is applied for 2-50 hours, indicating the long-term stability of the electrocatalyst. As used herein, the term ‘overpotential’ is referred to as the difference between the equilibrium potential for a given reaction (also called the thermodynamic potential) and the potential at which a catalyst operates at a specific current under specific conditions.

While not wishing to be bound to a single theory, it is thought that the unique morphology and properties of the WO₃₋ₓ nanosheets, and the CdS_{1-y} nanospheres work together synergistically to provide a high electrochemical performance. The structure of WO₃₋ₓ encourages the breakdown of water molecules into their constituent atoms and the formation of hydrogen from water protons and CdS_{1-y} increases the conductivity of the catalyst, enabling charge transfer. These allow the H released during H₂O molecule breakdown to be transferred to the CdS_{1-y} interface contact region and be converted into H₂.

The electrocatalyst of the present disclosure may also be used in water-splitting reactions. In some embodiments, the electrocatalyst may also be used in the field of batteries, fuel cells, photochemical cells, water splitting cells, electronics, water purification, hydrogen sensors, semiconductors (such as field-effect transistors), magnetic semiconductors, capacitors, data storage devices, biosensors (such as redox protein sensors), photovoltaics, liquid crystal screens, plasma screens, touch screens, OLEDs, antistatic deposits, optical coatings, reflective coverings, anti-reflection coatings, and/or reaction catalysis.

### EXAMPLES

The following examples demonstrate the method used for generating hydrogen. The examples are provided solely for illustration and are not to be construed as limitations of the present disclosure, as many variations thereof are possible without departing from the spirit and scope of the present disclosure.

### Example 1: Materials

Pure chemical reagents of sodium tungstate (Na₂WO₄·2H₂O) and cadmium chloride (CdCl₂·2.5H₂O), sodium sulfide (Na₂S·9H₂O), sodium borohydride (NaBH₄), potassium hydroxide (KOH), Nafion solution (5 wt. %), ethyl alcohol (C₂H₅OH), and hydrochloric acid (HCl of 36-38%) were purchased from Sigma Aldrich and used without further treatment. Millipore's Autopure technology was used to get deionized water (DIW).

### Example 2: Synthesis of WO₃₋ₓ Nanosheets

The WO₃₋ₓ nanosheets were synthesized using the ultrasonic process (FIG. 2A). First, 20 mL of HCl was added to 100 mL of 1.0 M Na₂WO₄·2H₂O in C₂H₅OH using sonication for 2 hours to form the suspension and then stirring the resulting suspension at room temperature for 6 hours. Next, 1 mL of 1.0% NaBH₄ solution was added dropwise and stirred for 2 hours. Consequently, WO₃₋ₓ nanosheets were obtained after washing the suspension with deionized water and drying it for 8 hours at 80° C. Finally, the dried powder was crushed and calcined for 3 hours at 700° C., then allowed to cool down naturally to ambient temperature, obtaining WO₃₋ₓ nanosheets.

### Example 3: Synthesis of CdS_{1-y} Nanospheres

The CdS_{1-y} nanospheres were synthesized using the ultrasonic process (FIG. 2B). First, 228 mg of CdCl₂·2.5H₂O was mixed in a beaker with C₂H₅OH of 100 mL. The beaker containing the mixture was vigorously swirled for 6 hours, followed by adding 1 mL of 0.1% NaBH₄ dropwise. Then, the mixture was sonicated for 30 minutes to ensure proper solution mixing. After 2 hours of ultrasonic processing, the solution instantly turned yellow when 78 mg of Na₂S·9H₂O was added. Lastly, the suspension was washed using distilled water and dried for 8 hours at 80° C. to get the CdS_{1-y} nanosphere.

### Example 4: Synthesis of WO₃₋ₓ@CdS_{1-y} Nanocomposites

The WO₃₋ₓ@CdS_{1-y} nanocomposites were synthesized using a simple ultrasonic-assisted laser irradiation technique (FIG. 2C). In this procedure, different mixtures of WO₃₋ₓ and CdS_{1-y} were prepared with the following percentages: WO₃₋ₓ/Y wt. % CdS_{1-y} (Y=5, 10, 20 and 30%). A homogenized mixture of 5 mg of CdS_{1-y} and 100 mg of WO₃₋ₓ was taken to prepare WO₃₋ₓ/5 wt. % CdS_{1-y}. The CdS_{1-y} powder was dispersed separately in DIW for an hour and mixed with WO₃₋ₓ powder, followed by sonication for another 1 hour. Each mixture was placed and irradiated by a laser for 30 minutes. The post-synthesis purification was unnecessary because no catalysts or intermediary chemicals were used to complete the laser irradiation procedure. Consequently, the synthesized products were pure without any contaminants. The prepared WCSNCs were named as Wₓ@Sₓ-5% (WO₃₋ₓ/5 wt. % CdS_{1-y}), Wₓ@Sₓ-10% (WO₃₋ₓ/10 wt. % CdS_{1-y}), Wₓ@Sₓ-20% (WO₃₋ₓ/20 wt. % CdS_{1-y}), and Wₓ@Sₓ-30% (WO₃₋ₓ/30 wt. % CdS_{1-y}) depending on the concentration of CdS_{1-y}.

### Example 5: Characterization Techniques

All the characterizations of the samples were carried out at room temperature. X-ray diffraction (XRD) analysis was performed to determine the crystal structures of samples (Rigaku D, Japan, XRD equipped with Cu-Kα line of wavelength, λ=0.154 nm, operated at 40 kV and 40 mA). The microstructures and morphology of the prepared WCSNCs electrocatalysts were examined using a scanning electron microscope (SEM) (JEOL, Japan) and transmission electron microscope (TEM) (JEM-2100F, Singapore). Energy-dispersive X-ray spectroscopy (EDS) spectra and maps of the samples were obtained for the elemental analyses, wherein the spectrophotometer was attached to the SEM machine. X-ray photoelectron spectroscopy (XPS) spectra of the samples were recorded (Thermo Scientific K-Alpha with Al-Kα line operated at 15 kV and 15 mA, manufactured by Thermo Fischer Scientific, Waltham, Massachusetts, U.S.A) to determine their active surface chemical states. C 1s peak at 284.8 eV was used as a reference, wherein the pass binding energy was 30 eV.

### Example 6: Electrochemical Measurement Techniques

The electrochemical characteristics of the obtained catalysts were assessed using a typical three-electrode setup on an AutoLab electrochemical workstation. The active working electrodes were modified on a glassy carbon (GC) surface and prepared by adding WCSNCs (4 mg) and 5 wt. % Nafion solution (50 μL) to C₂H₅OH (950 μL). Then, the resultant suspension was ultrasonicated for 20 minutes to generate homogenous catalyst ink. Later, the obtained catalyst ink of 5 μL was drop-cast onto the GC layer (mass loading ˜0.285 mg/cm²). After 12 hours of drying at room temperature, the catalyst-modified GC surface served as a working electrode. The KCl-saturated Ag/AgCl and graphite rods were references and counter electrodes, respectively. Using the Nernst relation (E_{RHE}=E_{Ag/AgCl}+0.0592 pH+0.1989 V), all potentials measured against an Ag/AgCl electrode were used to convert reversible hydrogen electrodes (RHE). Before the test, pure N₂ gas was purged into the solution constantly for about 30 minutes to eliminate oxygen. The polarization curves of the catalysts (immersed in a KOH solution of 1.0 M at pH 13.5) were recorded by linear sweep voltammetry (LSV of scan rate 10 mV/s). The polarization curves were used to generate the Tafel graphs. The resistance of the samples against charge transport in the range of 10⁵ and 10⁻¹ Hz was examined using an electrochemical impedance spectroscope (EIS). The electrochemical double layer capacitance (Cdl) of the samples in KOH solution (1.0 M) was determined by scanning CV in the scan speed range of 20-120 mV/s in the non-Faradaic region. The ECSA=Cdl/Cs values were evaluated in specific capacitance (Cs of mean value 35 μF/cm²). Chronopotentiometry measurement was used to examine the stability and durability of the proposed catalysts at 10 mA/cm². In addition, the cycling performance of the proposed electrode was evaluated by repeating LSV for 1000 cycles to measure the catalyst performance.

### Example 7: Characterization

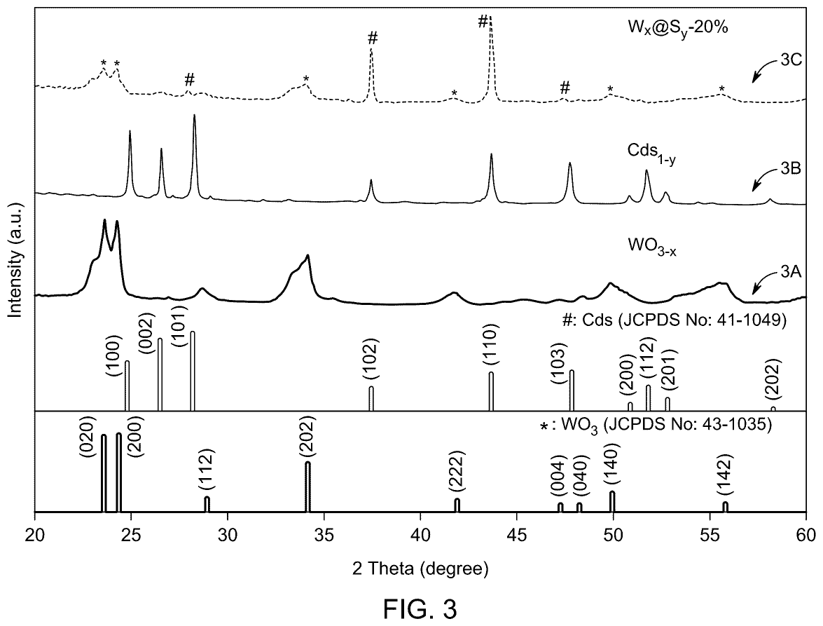

FIG. 3 displays the XRD patterns of various samples. XRD profile of WO₃₋ₓ (designated by a reference character 3A) revealed weak broad peaks indicating a monoclinic phase structure (JCPDS No. 43-1035). XRD profile of CdS_{1-y} (designated by a reference character 3B) showed a hexagonal phase structure for diffraction peaks (JCPDS No. 41-1049). After loading CdS_{1-y} with WO₃₋ₓ, the XRD patterns of Wₓ@Sₓ-20% (designated by a reference character 3C) show patterns similar to the WO₃₋ₓ diffraction peak, demonstrating no disruption in the lattice structures of WO₃₋ₓ due to the addition of CdS_{1-y}. The composites were successfully prepared, as shown by the presence of six diffraction peaks at 23.64°, 24.28°, 34.12°, 41.68°, 49.88°, and 55.71°, which correspond to the (020), (200), (202), (222), (140), and (142) planes of WO₃₋ₓ, respectively. In the meanwhile, the presence of four diffraction peaks at 28.28°, 37.44°, 43.68°, and 47.76°, which correspond to the (101), (102), (110), and (103) planes of CdS_{1-y} in the Wₓ@Sₓ-20%, indicating effective coupling of CdS_{1-y} with WO₃₋ₓ.

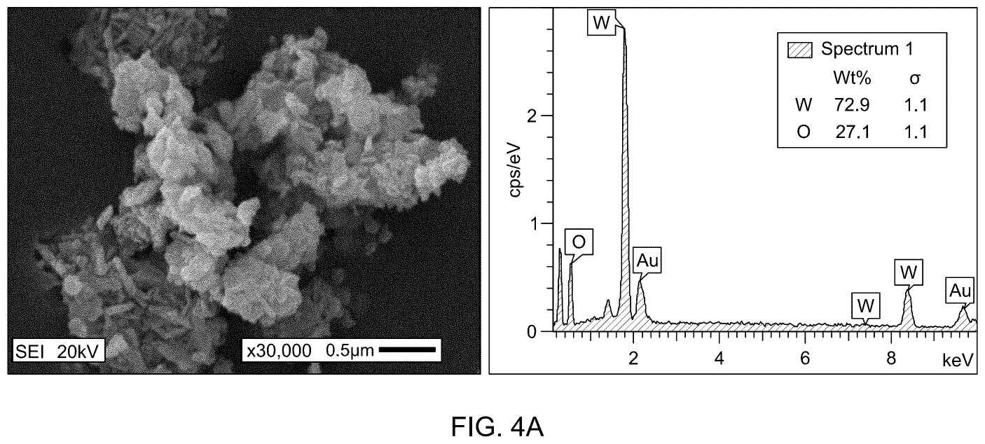

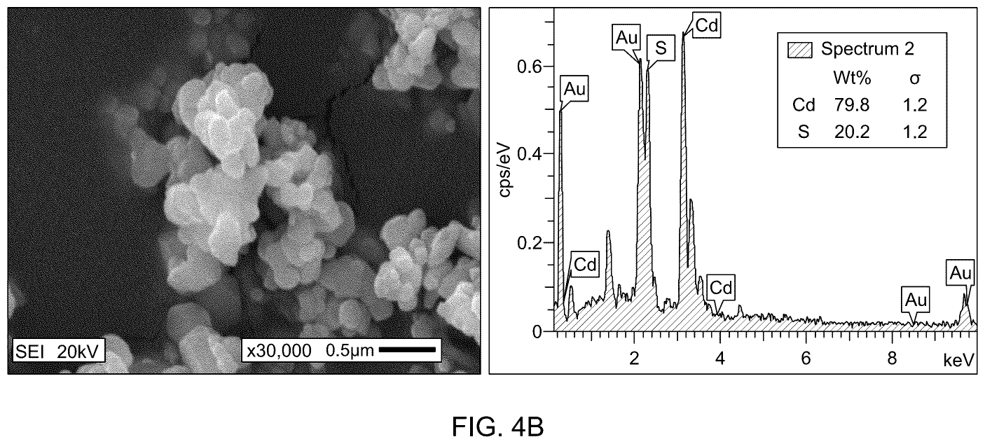

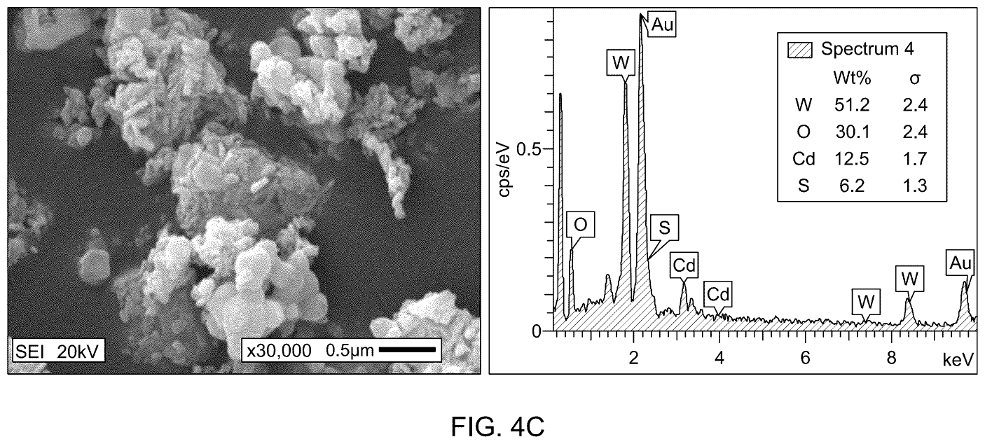

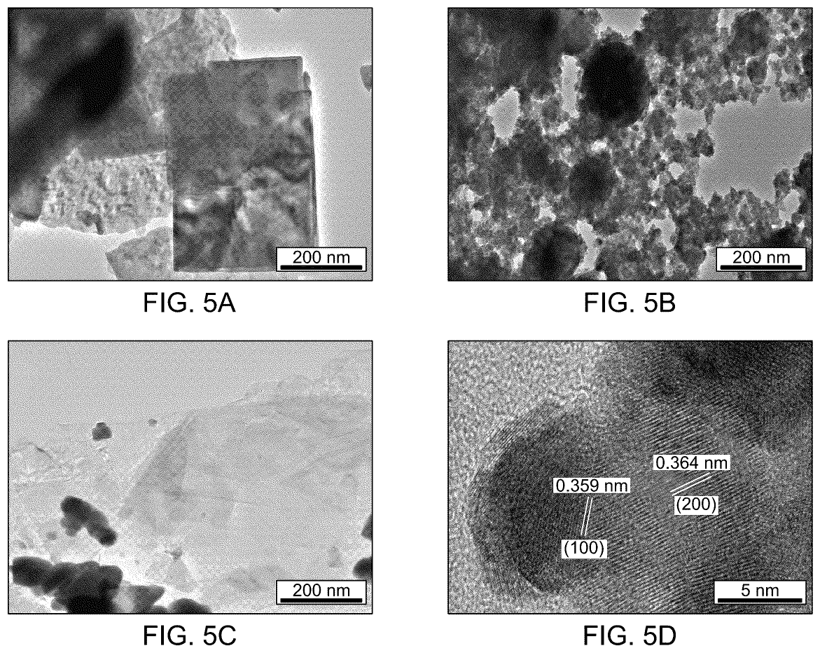

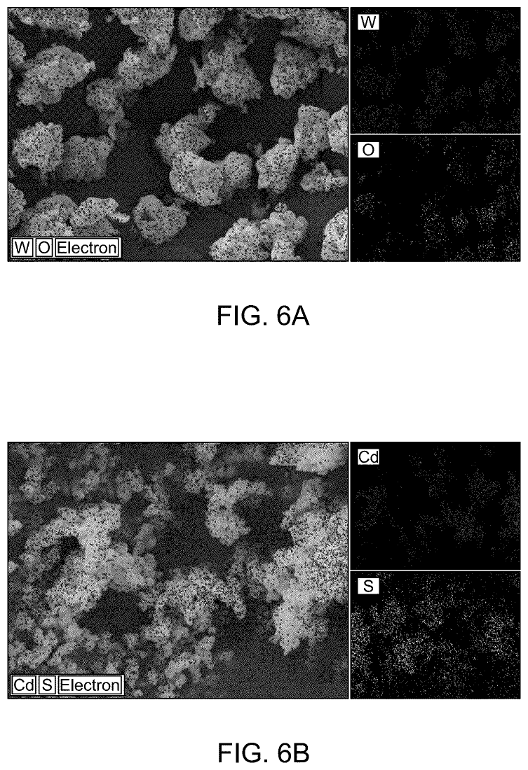

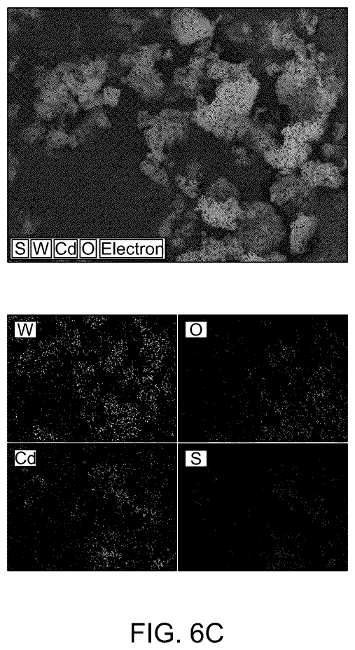

FIGS. 4A-4C illustrate SEM images and corresponding EDX spectra of WO₃₋ₓ, CdS_{1-y}, and Wₓ@Sₓ-20%. Pure CdS_{1-y} (FIG. 4B) consisted of nanospheres evenly distributed in a monodispersed cluster. The presence of ultrathin nanosheets of WO₃₋ₓ (FIG. 4A) was beneficial for loading CdS_{1-y} nanospheres. The CdS_{1-y} nanospheres were grown directly on top of WO₃₋ₓ ultrathin nanosheets while maintaining their original shapes when WO₃₋ₓ was included in the reaction mixture (FIG. 4C). FIGS. 5A-5C and FIGS. 6A-6C display the TEM images and EDX maps of WO₃₋ₓ, CdS_{1-y}, and Wₓ@Sₓ-20% specimen. The HRTEM image of Wₓ@Sₓ-20% (FIG. 5D) showed the robust connectivity of WO₃₋ₓ and CdS_{1-y} nanoparticles in the matrix. The observed d-spacing of WO₃₋ₓ and CdS_{1-y} obtained from the lattice fringes were 0.364 and 0.359 nm, respectively, corresponding to the lattice planes of (200) and (100), respectively. The presence of W, O, Cd, and S in the EDX spectra, further Au peak relating to the use of Au-coated grids for the analysis (FIGS. 4A-4C) and elemental mappings (FIGS. 6A-6C) indicated that CdS_{1-y} was strongly coupled to WO₃₋ₓ, which was adequate for improvement in the charge transfer between CdS_{1-y} and WO₃₋ₓ.

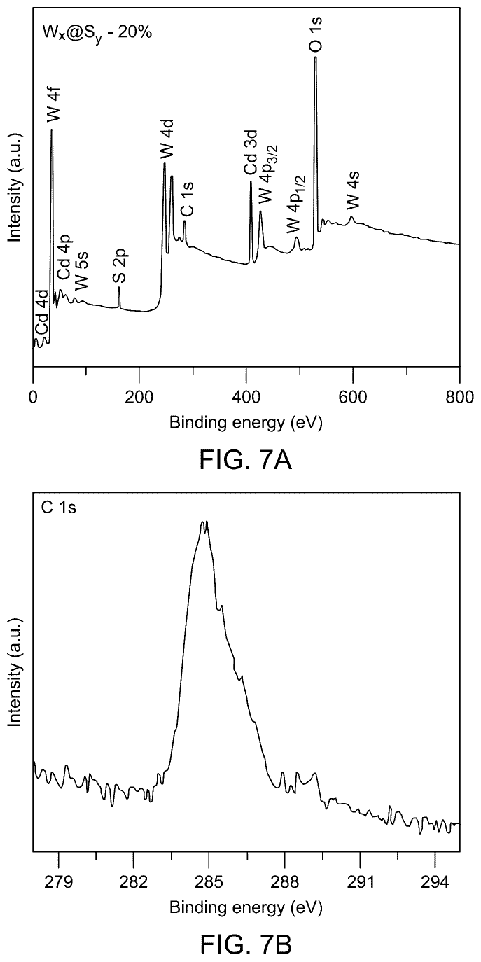

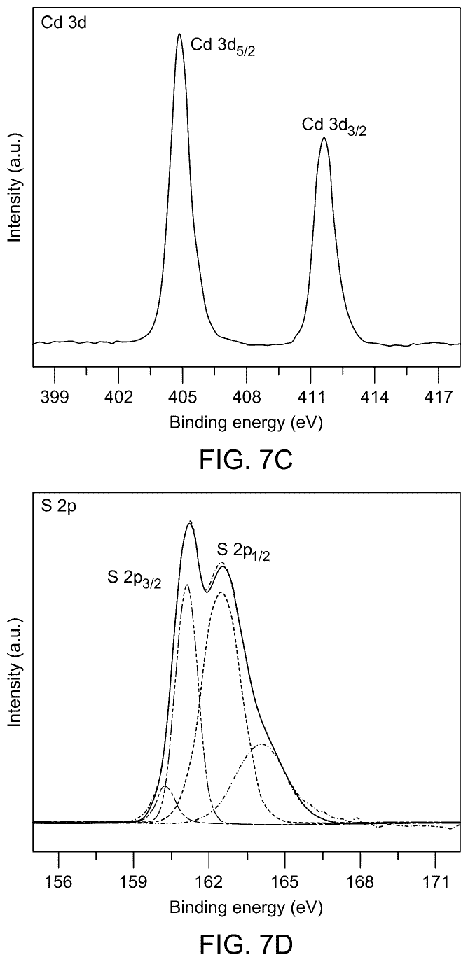

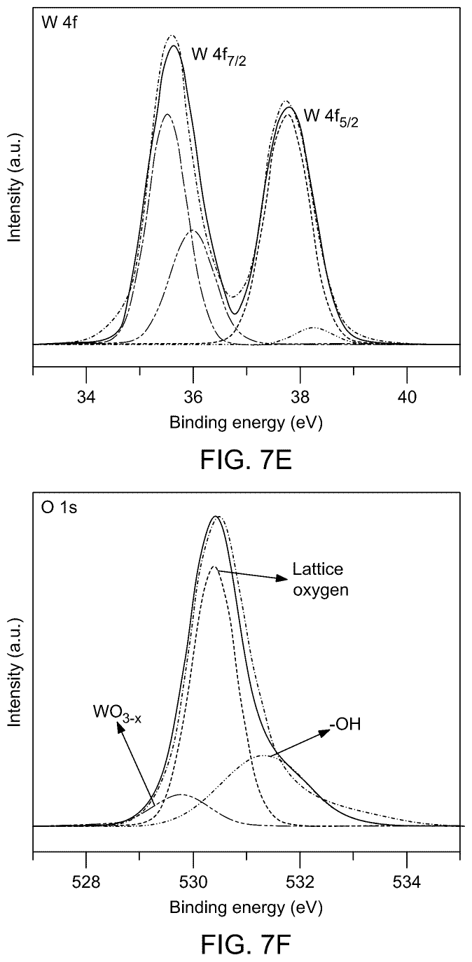

The XPS spectra (FIGS. 7A-7F) were analyzed to identify the surface chemical state of Wₓ@Sₓ-20%. The survey spectrum (FIG. 7A) detected the elements S, O, Cd, W and C, wherein C originated from the substrate used. The complete absence of other elements in the prepared WCSNC confirmed its high purity. The binding energy (BE) of the C 1s peak (284.8 eV) was taken as the reference standard (FIG. 7B). The two peaks can be seen in the Cd 3d high-resolution spectra (FIG. 7C) at 404.83 eV and 411.63 eV, which may be attributed to the typical spin-orbit splitting between 3d_{5/2} and 3d_{3/2} of Cd²⁺. FIG. 7D shows that the S 2p spectra exhibited sharp peaks corresponding to 2p_{3/2} and 2p_{1/2} of S at BE of 161.27 and 162.47 eV, assigned to the metal-sulfur bonds. The existence of the other two peaks was due to the sulfur vacancies. Two sets of peaks were observed in the 4f spectrum of W (FIG. 7E), wherein the peaks for 4f_{7/2} and 4f_{5/2} of W were located at 35.51 and 37.73 eV (corresponding to W⁶⁺) and the peaks corresponding to 4f chemical states of W were ranged from +4 to +6. The formation of a sub-stoichiometric version of WO₃₋ₓ in the form of W⁵⁺ facilitates shear defects and charge transfer. Meanwhile, oxygen vacancies are detected by analyzing the O 1s spectra (FIG. 6F). Three distinctive peaks in Is spectra of O centered at 529.75, 530.40, and 531.33 eV were correspondingly due to the presence of oxygen in WO₃₋ₓ as well as hydroxyl, and lattice oxygen. Three peaks convolve with the O 1s of WO₃₋ₓ, confirming the generation of oxygen vacancies in the proposed WCSNCs. XPS results also verified a successful blending of CdS_{1-y} with WO₃₋ₓ and the formation of S and O vacancies in the NCs required for HER performance improvement.

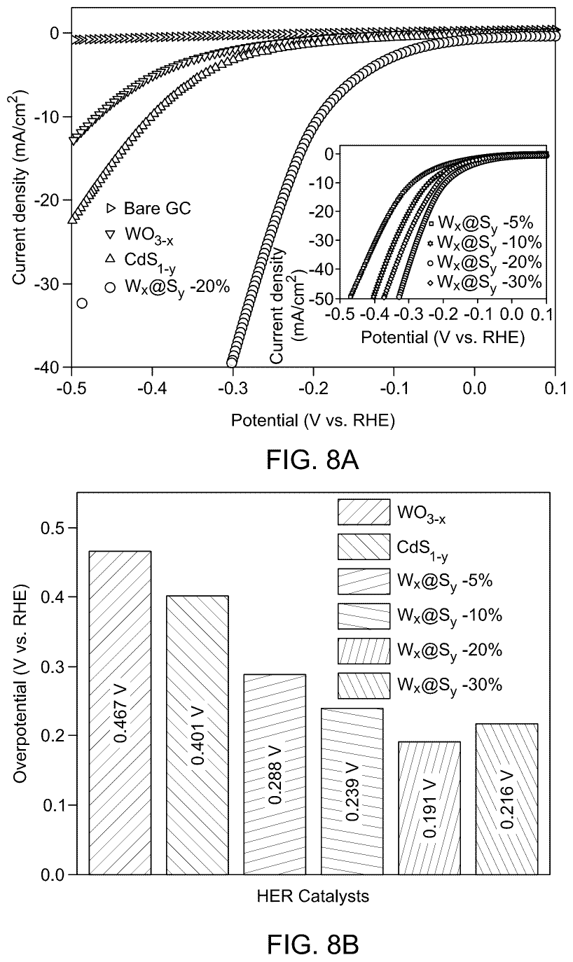

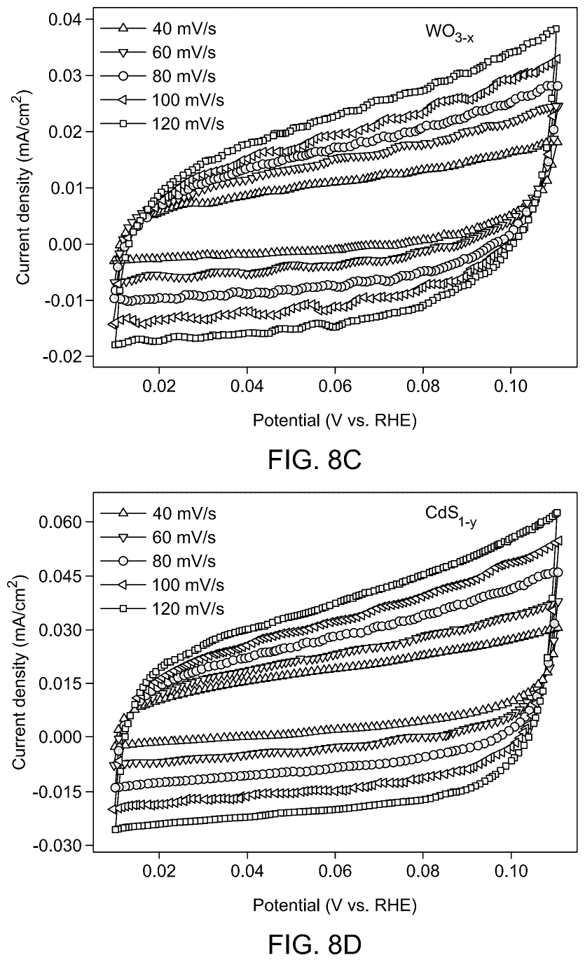

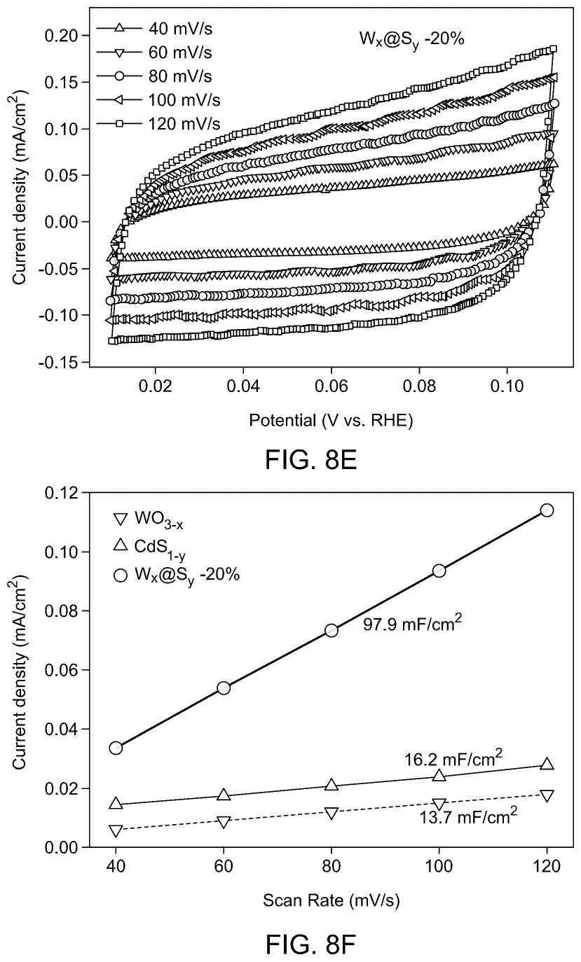

FIGS. 8A-8F show the tested samples' polarization curves, HER activity (overpotentials at 10 mA/cm²), CV curve, and Cdl plot. Wₓ@C-20% specimen showed a low overpotential (η10=0.191 V) and best performance compared to WO^{3-x} (0.467 V), CdS_{1-y} (0.401 V), Wₓ@Sₓ-5% (0.288 V), Wₓ@Sₓ-10% (0.239 V), and Wₓ@Sₓ-30% (0.216 V), respectively (FIG. 8A). However, the HER impact progressively diminishes when the CdS_{1-y} concentration exceeds 20 wt. %. In addition, the observed increase in the HER overpotential of Wₓ@Sₓ-30% to 0.216 V was mainly due to the increase of CdS_{1-y} to WO₃₋ₓ concentration (the sole active phase) and excess CdS_{1-y} that acted as the charge carrier combination center. In addition to the data presented here, it is worth mentioning that the synergistic impact of WO₃₋ₓ coupled with CdS_{1-y} is responsible for the improved HER catalytic activity of the synthesized Wₓ@Sₓ-20%. In the present disclosure, WO₃₋ₓ exhibits negligible hydrogen generation activity, most likely because WO₃₋ₓ must overcome high resistance and weak catalytic activity to achieve the HER criteria. FIG. 8B depicts the overpotential histogram bar plot of WO₃₋ₓ, CdS_{1-y}, and Wₓ@Sₓ-20%. A detailed comparison of the electrocatalyst of the present disclosure with other advanced electrocatalysts in alkaline media is shown in Table 1.

TABLE 1
A comparison of the HER activities of various
electrocatalysts in the alkaline electrolyte.

| | Overpotential (V) | Tafel Slope | |
|---|---|---|---|
| Catalysts | (10 mA/cm²) | (mV/dec) | Reference |
| Wₓ@Sₓ-20% | 0.191 | 61.9 | Present |
| | | | disclosure |
| WO₃ | 0.219 | 102 | A |
| WO₃/CuO | 0.442 | 67 | B |
| WO₃/ZrO₂ | 0.200 | 94 | A |
| CoS/Ag | 0.284 | 70 | C |
| Ru/WO₃ | 0.320 | — | D |
| WS₂/WO₃ | 0.395 | 50 | E |
| NiWS | 0.201 | 93 | F |
| Pt/CdS | 0.103 | 98.5 | G |
| CdS@Ni₃S₂ | 0.367 | — | H |
| CdS@Cu₂S | 0.447 | — | H |
| NiS₂/CC | 0.243 | 104 | I |
| Ni₃S₂ NWs | 0.200 | 141 | J |
| MoS₂/TiC | 0.238 | — | K |
| Ni/Mo₂C-PC | 0.179 | 101 | L |

Reference A: J. Wei, J. Wang, W. Guo, H. Tang, J. Li, Tailoring the acidity of WO₃/ZrO₂ to regulate the energy barrier of water dissociation in alkaline hydrogen evolution, Chem Eng J. 460 (2023) 141783.
Reference B: K. M. Katubi, A.-Z. Warsi, F. Aziz, Z. A. K. Khattak, M. F. Warsi, M. S. Al-Buriahi, Z. A. Alrowaili, S. Yousaf, Tungsten oxide-copper oxide supported on reduced graphene oxide as a proficient electrocatalyst with enhanced hydrogen evolution efficiency in an alkaline media, Current Applied Physics. 51 (2023) 80-90.
Reference C: P. M. Pataniya, V. Patel, P. Sahatiya, D. J. Late, C. K. Sumesh, Hydrogen evolution reaction in acidic and basic medium on robust cobalt sulphide electrocatalyst, Surfaces Interfaces. 34 (2022) 102319.
Reference D: X. Xie, Y. Fan, W. Tian, M. Zhang, J. Cai, X. Zhang, J. Ding, Y. Liu, S. Lu, Construction of Ru/WO₃ with hetero-interface structure for efficient hydrogen evolution reaction, J Energy Chem. 83 (2023) 150-157.
Reference E: X. Shang, Y. Rao, S. S. Lu, B. Dong, L. M. Zhang, X. H. Liu, X. Li, Y. R. Liu, Y. M. Chai, C. G. Liu, Novel WS₂/WO₃ heterostructured nanosheets as efficient electrocatalyst for hydrogen evolution reaction, Mater Chem Phys. 197 (2017) 123-128.
Reference F: K. Premnath, J. Madhavan, S. Prasad, M. J. Aljaafreh, M. S. AlSalhi, S. P. Loke, Ultra-efficient, low-cost and carbon-supported transition metal sulphide as a platinum free electrocatalyst towards hydrogen evolution reaction at alkaline medium, Int J Hydrogen Energy. 47 (2022) 41974-41983.
Reference G: Y. Fu, J. Li, J. Li, Photo-improved hydrogen evolution reaction activity of the Pt/CdS electrocatalyst, Prog Nat Sci Mater Int. 29 (2019) 379-383.
Reference H: M. Sun, X. Guan, Q. huang, Q. Gao, S. Zhang, X. Cai, Y. Fang, F. Peng, S. Yang, CdS@Ni₃S₂/Cu₂S electrode for electrocatalysis and boosted photo-assisted electrocatalysis hydrogen production, Sep Purif Technol. 319 (2023) 124085.
Reference I: C. Tang, Z. Pu, Q. Liu, A. M. Asiri, X. Sun, NiS2 nanosheets array grown on carbon cloth as an efficient 3D hydrogen evolution cathode, Electrochim Acta. 153 (2015) 508-514.
Reference J: C. Ouyang, X. Wang, C. Wang, X. Zhang, J. Wu, Z. Ma, S. Dou, S. Wang, Hierarchically porous Ni3S2 nanorod array foam as highly efficient electrocatalyst for hydrogen evolution reaction and oxygen evolution reaction, Electrochim Acta. 174 (2015) 297-301.
Reference K: M. Yu, S. Zhao, H. Feng, L. Hu, X. Zhang, Y. Zeng, Y. Tong, X. Lu, Engineering thin MoS₂ nanosheets on TiN nanorods: Advanced electrochemical capacitor electrode and hydrogen evolution electrocatalyst, ACS Energy Lett. 2 (2017) 1862-1868.
Reference L: Z. Y. Yu, Y. Duan, M. R. Gao, C. C. Lang, Y. R. Zheng, S. H. Yu, A one-dimensional porous carbon-supported Ni/Mo2C dual catalyst for efficient water splitting, Chem Sci. 8 (2017) 968-973.

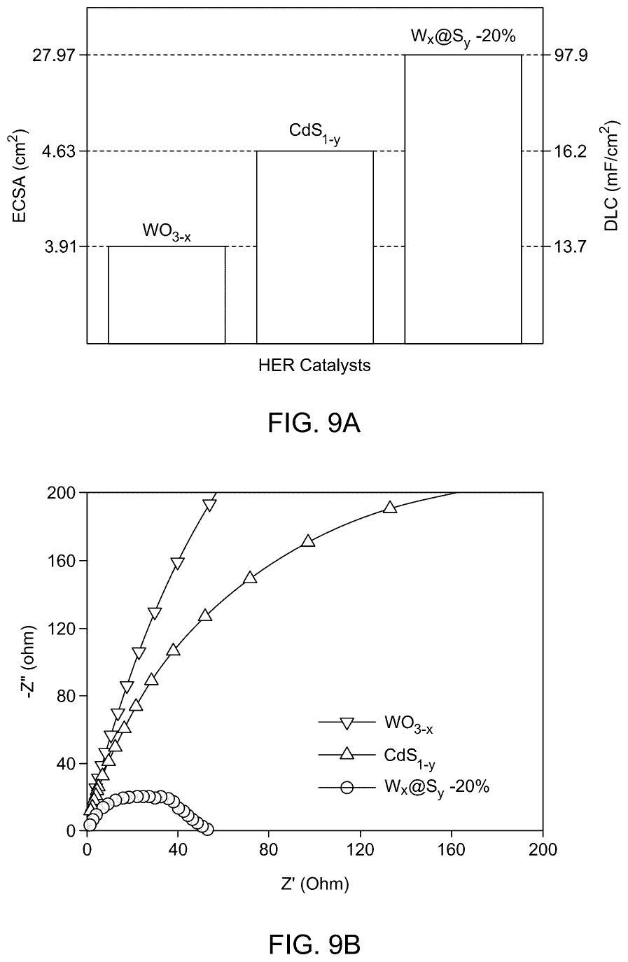

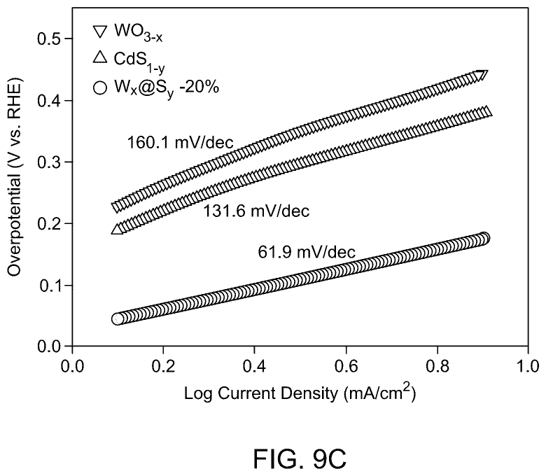

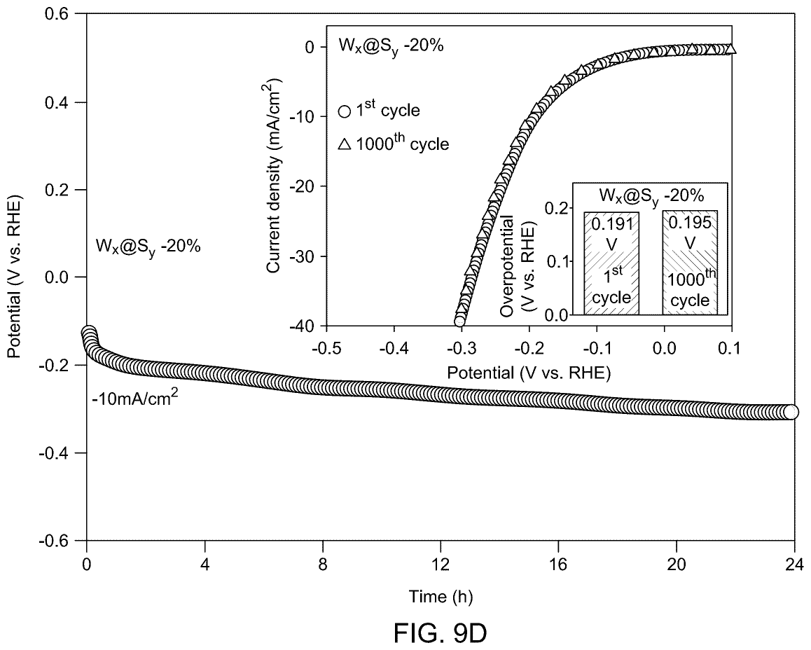

FIG. 8C-8E depicts the CV curve of the WO₃₋ₓ and CdS_{1-y} (in basic media), which was used to determine the electrochemical Cdl values in the non-Faradaic region, estimating the ECSA values of the obtained WCSNC-based catalysts. The Cdl values (FIG. 8F) were computed and presented based on the initial findings. Among samples, the Wₓ@Sₓ-20% sample showed the highest Cdl value of 97.9 mF/cm², about 7.1 times higher than the bare WO₃₋ₓ (13.7 mF/cm²), and approximately 6.0 times more than the pure CdS_{1-y} (16.2 mF/cm²). Consequently, among the prepared WO₃₋ₓ and CdS_{1-y} catalysts, the ECSA of Wₓ@Sₓ-20% is the greatest, with a calculated value of 27.97 cm² (FIG. 9A). The Wₓ@Sₓ-20% sample showed excellent HER activity, affirming that the synergistic effects of WO₃₋ₓ and CdS_{1-y} that could boost its intrinsic activity.

EIS spectra of the WCSNC-based catalysts were analyzed to determine the electrochemical kinetic processes responsible for improved HER activity. The Nyquist plots derived from EIS data are shown in FIG. 9B. As seen in Nyquist plots, Wₓ@Sₓ-20% has a substantially lower charge transfer resistance than other samples. A high charge transport rate corresponds to a low charge transfer resistance and vice versa. As a result, the Wₓ@Sₓ-20% improves HER performance by decreasing charge transfer resistance and increasing charge transport rate during the electrocatalytic process. The Tafel slopes were used to describe the reaction kinetics of the catalysts, as illustrated in FIG. 9C. When compared to WO₃₋ₓ (160.1 mV/dec) and CdS_{1-y} (131.6 mV/dec), the Tafel slope of Wₓ@Sₓ-20% (61.9 mV/dec) was lower. The results indicated that the alkaline HER kinetics were the fastest in the Wₓ@Sₓ-20% catalysts. The HER process can be explained in three stages such as discharge (Volmer reaction), electrochemical desorption (Heyrovsky reaction) and Tafel recombination with the corresponding Tafel slopes of 120, 40 and 30 mV/dec. The achieved Tafel slope of Wₓ@Sₓ-20% (61.9 mV/dec) was intermediate between the Volmer and Heyrovsky reactions; the Volmer-Heyrovsky mechanism plays a role in Wₓ@Sₓ-20% for HER in basic media. The mechanism for HER is based on the above analysis results. The WO₃₋ₓ surface is superior for H₂O adsorption and dissociation, while the CdS_{1-y} surface performs better for Hads adsorption. These allowed the H released during H₂O molecule breakdown to be transferred to the CdS_{1-y} interface contact region and converted into H₂.

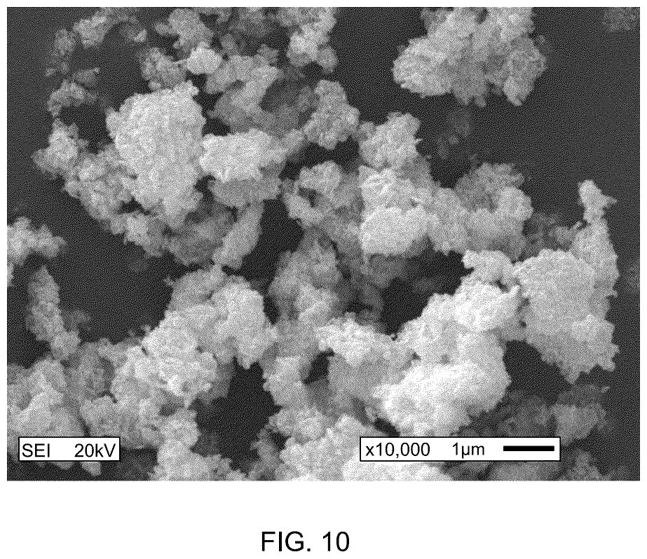

A suitable catalyst should have both effective HER activity and high stability. Long-term chronopotentiometry (CP) and CV were used to assess the stability of the catalysts. The CP results show the decaying overpotential caused by the continuous HER process over 24 hours of Wₓ@Sₓ-20% (FIG. 9D). Before and after 1000 CV scans, the polarization curve of Wₓ@Sₓ-20% virtually overlapped each other (inset FIG. 9D). The observed overpotential values at a current density of 10 mA/cm² are 191 mV for the first cycle and 195 mV after 1000 cycles, indicating only a slight decay in electrochemical performance after 1000 cycles. It clearly shows that the electrochemical features of Wₓ@Sₓ-20% are almost retained even after 1000 cycles. Wₓ@Sₓ-20% showed remarkable HER stability performance in the alkaline medium. Furthermore, an SEM analysis of the electrocatalyst following the stability performance (FIG. 10) reveals that the catalyst particles are agglomerated but remain almost the same, which means that the electrocatalyst is highly stable in nature and consistent with the stability results in FIG. 9D.

The achieved improvement in the catalytic activity and stability of Wₓ@Sₓ-20% was ascribed to the following reasons: (i) The Wₓ@Sₓ-20%, with its ultrathin nanosheets and nanosphere shapes, has a greater electrochemical active surface area, allowing for increased contact between an electrocatalyst and an electrolyte, and by exploiting these active sites, resulting in improved catalytic performance, (ii) the Nyquist plots have a smaller diameter in alkaline media, indicating reduced resistance during charge transfer and faster electrode kinetics, and (iii) the synergistic impact of dual active oxygen and sulfur vacancies defects in WO₃₋ₓ and CdS_{1-y} crystal facets lead to substantially greater electrocatalytic HER performance of Wₓ@Sₓ-20%. The structure of WO₃₋ₓ encourages the breakdown of water molecules into their constituent atoms and the formation of hydrogen from water protons. Second, CdS_{1-y} increases the conductivity of the catalyst, enabling charge transfer.

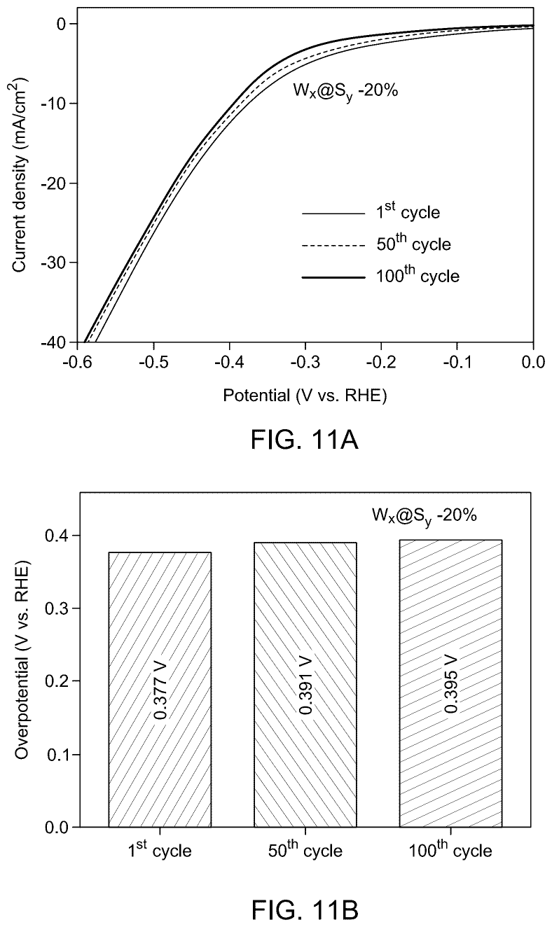

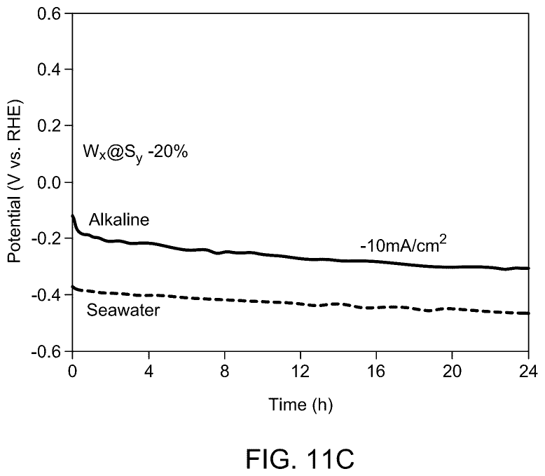

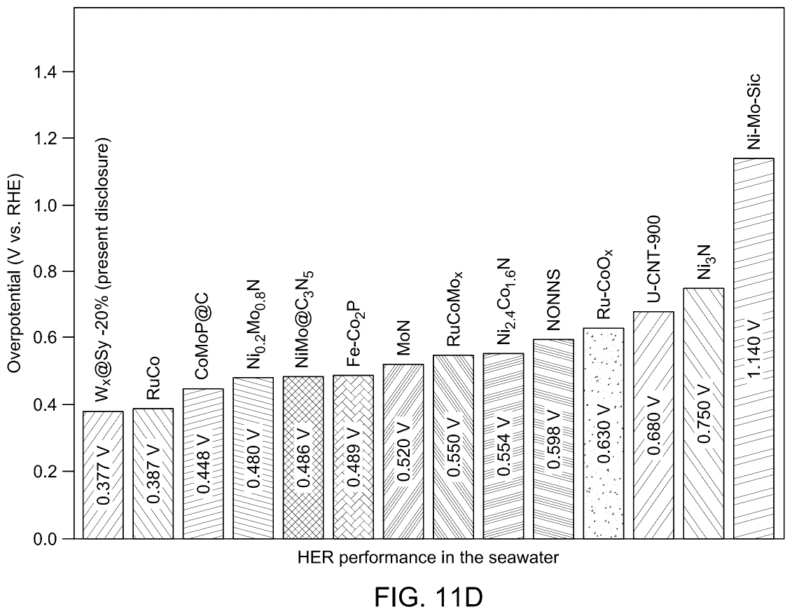

The direct electrolysis of seawater is an efficient and environmentally friendly method of producing hydrogen energy. The Wₓ@Sₓ-20% electrocatalytic HER performance in natural seawater (pH ˜8.0, collected on Dammam Beach, Saudi Arabia) was assessed. FIG. 11A illustrates that the LSV polarization curve of Wₓ@Sₓ-20% decreases slightly with increasing testing cycle over the 1st, 50th, and 100th cycles, enabling the overpotential of 0.377, 0.391, and 0.395 V to deliver current density of 10 mA/cm² and showed higher activity than the commercial 20 wt. % Pt/C catalyst under high potentials (>0.749 V vs. RHE), respectively. FIG. 11B depicts the overpotentials of the different Wₓ@Sₓ-20% cycles necessary to achieve a current density of 10 mA/cm². Seawater has several chemicals, including ions, which may degrade and poison the electrocatalyst. As a result, the stability of the catalyst is important for long-term electrolysis. The chronopotentiometry curves revealed that Wₓ@Sₓ-20% could maintain activity for 24 hours at a current density of 10 mA/cm² (FIG. 11C).

Numerous modifications and variations of the present disclosure are possible in light of the above teachings. It is therefore to be understood that within the scope of the appended claims, the invention may be practiced otherwise than as specifically described herein.

1. A method of generating hydrogen, comprising:
applying a potential of greater than 0 to 2.0 V to an electrochemical cell,
wherein the electrochemical cell is at least partially submerged in an aqueous solution,
wherein on applying the potential water in the aqueous solution is reduced thereby forming hydrogen,
wherein the electrochemical cell comprises:
an electrocatalyst; and
a counter electrode;
wherein the electrocatalyst comprises:
a substrate;
WO₃₋ₓ nanosheets; and
CdS_{1-y} nanospheres,
wherein x is from greater than 0 to less than 3,
wherein y is from greater than 0 to less than 1,
wherein the CdS_{1-y} nanospheres are dispersed on the WO₃₋ₓ nanosheets to form a nanocomposite,
wherein the nanocomposite is dispersed on a surface of the substrate,
wherein the WO₃₋ₓ nanosheets have an average length of 600-800 nm and an average width of 300-500 nm, and
wherein the CdS_{1-y} nanospheres have an average diameter of 10-50 nm.

2. The method of claim 1, wherein the nanocomposite comprises 1-40 wt. % of the CdS_{1-y} nanospheres, based on a total weight of the nanocomposite.

3. The method of claim 1, wherein the nanocomposite comprises 60-99 wt. % of the WO₃₋ₓ nanosheets, based on a total weight of the nanocomposite.

4. The method of claim 1, wherein the WO₃₋ₓ nanosheets have a monoclinic crystal structure.

5. The method of claim 1, wherein the CdS_{1-y} nanospheres have a hexagonal crystal structure.

6. The method of claim 1, wherein the WO₃₋ₓ nanosheets have a thickness of less than 5 nm.

7. The method of claim 1, wherein particles of the CdS_{1-y} nanospheres form clusters having an average size of 500-1,000 nm.

8. The method of claim 7, wherein the clusters at least partially cover a surface of particles of the WO₃₋ₓ nanosheets.

9. The method of claim 1, wherein the nanocomposite comprises W, S, Cd, and O.

10. The method of claim 1, wherein the nanocomposite comprises 40-60 wt. % W, 1-10 wt. % S, 5-15 wt. % Cd, and 20-40 wt. % O.

11. The method of claim 1, wherein the CdS_{1-y} nanospheres have at least 1% sulfur vacancies.

12. The method of claim 1, wherein the WO₃₋ₓ nanosheets have at least 1% oxygen vacancies.

13. The method of claim 1, wherein the nanocomposite is made by a method comprising:
mixing the WO₃₋ₓ nanosheets and the CdS_{1-y} nanospheres in water to form a mixture; and
irradiating the mixture for at least 10 minutes with a laser to form the nanocomposite.

14. The method of claim 13, wherein the method of making the nanocomposite further comprises sonicating the mixture for at least 30 minutes prior to the irradiation.

15. The method of claim 13, wherein the laser has a wavelength of 500-600 nm.

16. The method of claim 1, wherein the WO₃₋ₓ nanosheets are made by a method comprising:
mixing an acid and a tungstate salt in a solvent and sonicating for at least 30 minutes to form a suspension;
adding a reducing agent to the suspension to form a precipitate; and
calcining the precipitate for 1-10 hours at a temperature of 600-1000° C. to form the WO₃₋ₓ nanosheets.

17. The method of claim 1, wherein the CdS_{1-y} nanospheres are made by a method comprising:
mixing a cadmium salt in a solvent to form a mixture;
adding a reducing agent to the mixture and sonicating for at least 30 minutes to form a second mixture; and
adding a sulfur salt to the second mixture to form the CdS_{1-y} nanospheres.

18. The method of claim 1, wherein the electrocatalyst has an overpotential of 180-200 millivolts (mV) per decade.

19. The method of claim 1, wherein the aqueous solution comprises at least one base selected from the group consisting of an alkaline earth metal hydroxide and an alkali metal hydroxide.

20. The method of claim 1, wherein the aqueous solution is seawater.
